(19) United States
(12) Patent Application Publication
(10) Pub. No.: US 2020/0202071 A1
(43) Pub. Date: Jun. 25, 2020

(54) CONTENT SCORING

(71) Applicant: Factmata Limited, London (GB)

(72) Inventor: Dhruv Ghulati, London (GB)

(21) Appl. No.: 16/643,573

(22) PCT Filed: Aug. 29, 2018
(86) PCT No.: PCT/GB2018/052440

§ 371 Date: Mar. 1, 2020

Related U.S. Application Data
(60) Provisional application No. 62/551,687, filed on Aug. 29, 2017.

(30) Foreign Application Priority Data
Aug. 29, 2017 (GB) 1713821.5

(51) Int. Cl. G06F 40/216; G06F 16/907; G06F 16/9535; G06F 16/9032; G06F 16/903; G06Q 50/00; G06N 5/04

(52) U.S. Cl. CPC G06F 40/216; G06F 16/907; G06F 16/9535; G06N 5/046; G06F 16/90335; G06Q 50/01; G06F 16/90332

(57) ABSTRACT

The present invention relates to a system and method for verification scoring and/or automated fact checking. More particularly, the present invention relates to automated content scoring based upon an ensemble of algorithms and/or automated fact checking, for example in relation to online journalistic articles, user generated content, blog posts, and user generated comments. Aspects and/or embodiments seek to provide a method of generating a content score for journalistic and other media content, provided with clear protocols and schemata in place and a verifiable method for the reasoning behind the score for such content.

### CROSS-REFERENCE TO RELATED APPLICATIONS

This Application is a U.S. Patent Application claiming the benefit of PCT International Application No. PCT/GB2018/052440, filed on 29 Aug. 2018, which claims the benefit of U.K. Provisional Application No. 1713821.5, filed on 29 Aug. 2017, and U.S. Provisional Application No. 62/551,687, filed on 29 Aug. 2017, all of which are incorporated in their entireties by this reference.

### TECHNICAL FIELD

The present invention relates to a system and method for verification scoring and/or automated fact checking. More particularly, the present invention relates to automated content scoring based upon an ensemble of algorithms and/or automated fact checking, for example in relation to online journalistic articles, user generated content, blog posts, and user generated comments.

### BACKGROUND

Owing to the increasing usage of the internet, and the ease of generating content on micro-blogging and social networks like Twitter and Facebook, articles and snippets of text are created on a daily basis at an ever-increasing rate. However, unlike more traditional publishing platforms like digital newspapers, micro-blogging platforms and other online publishing platforms allow a user to publicise their statements without a proper editorial or fact-checking process in place.

Writers on these platforms may not have expert knowledge or research the facts behind what they write, and currently there is no obligation to do so. Content is incentivised by catchiness and that which may earn most advertising click-throughs, rather than quality and informativeness. Therefore, a large amount of content to which internet users are exposed may be at least partially false or exaggerated, but still shared as though it were true.

Currently, the only way of verifying articles and statements made online is by having experts in the field of the subject matter either approve content once it is published or before it is published. This requires a significant number of reliable expert moderators to be on hand and approving content continuously, which is not feasible.

Additionally, existing methods/systems for verifying content which are not automated are unscalable, costly, and very labour-intensive.

### SUMMARY OF THE INVENTION

Aspects and/or embodiments seek to provide a method of generating a content score for journalistic and other media content, provided with clear protocols and schemata in place and a verifiable method for the reasoning behind the score for such content.

According to a first aspect, there is provided a method of determining a score indicative of the factual accuracy of information, comprising the steps of: receiving input data from a network of users, the input data comprising metadata, textual content and/or video content; providing to the network of users one or more elements of reference data; performing an algorithmic analysis of the received input data in relation to the reference data; and determining a probabilistic content score based on the algorithmic analysis, wherein the probabilistic content score reflects a verified confidence measure for the input data.

Trust or accreditation scores exist for a number of household uses, for example a house's energy efficiency, a financial bond, a computer's likelihood of catching a virus, or a financial credit history. Therefore, it is proposed to establish a content score on journalistic and other media content, provided with clear protocols and schemata in place and an explainable method for the reasoning behind the score for such content. Media content may include media from Twitter, Facebook, blogging websites, and news articles. Such a score may be in the form of a “content score” for claims, articles, sources, and websites, which openly characterises the reason for an extract of text being misleading or not, based on clear parameters and weightings that are algorithmically transparent.

Optionally, the method further comprising the step of: automatically detecting the input data as misleading content based on the algorithmic analysis, wherein the misleading content is verified by the probabilistic content score.

By providing a content score in the form of a confidence measure, for example according to the apparent trustworthiness of the content, a consumer of such content maybe more equipped as to whether to take such content at face value, or whether the information being presented to them is likely to be false and therefore should not be believed.

Optionally, the method further comprising the step of: identifying one or more individual claims within the input data, wherein each individual claim is operable to receive a separate content score. In the context of this application, the term “claim” refers to content that needs to be verified.

Journalistic articles, for example blogs, Tweets, and news articles, are all sources from which a large number of internet users receive information. Therefore, if the information therein is untrustworthy and/or false, the said incorrect information may be disseminated rapidly by uninformed users. If a user is informed at the point of use that the article is not trustworthy, then they may be encouraged not to share the article and potentially do their own research to find out the truth. A journalistic article may also refer to what is herein termed an “atomic unit” of user generated data, for example a single Tweet.

Optionally, the algorithmic analysis is performed using the metadata associated with the input data.

The input data, for example an online newspaper article, may comprise a number of separate pieces of information. Each separate piece of information may be referred to as a claim. Some parts of such an article may be more trustworthy than other parts, and it can be helpful to know which parts are more trustworthy than others, as opposed to providing a blanket score for the entire article.

Optionally, the metadata comprises one or more of: a profile of one or more authors; a location; and/or professional details regarding one or more authors and/or one or more publishing bodies.

Associated metadata, for example a profile of an author, may provide a significant amount of useful information used to establish a more accurate content score. If an author has previously written a number of very untrustworthy articles, then it is more likely that their latest article is not to be taken at face value than an author with meticulously researched claims and a perfect trustworthiness content score on all their previous articles. Associated metadata may also include not just the metadata of the article, but what other news outlets are publishing in reference to the article. This may be referred to as “surrounding external context”, which may be gathered using a digital crawler in real time which is configured to access such publications.

Optionally, the algorithmic analysis comprises one or more of: Reviewing known measures of journalistic quality; reviewing one or more headlines in relation to the input data; reviewing the source of the input data; reviewing the relationship between the source of the input data and one or more users; reviewing the domain from which the input data is received, in particular autobiographical data obtained from the domain; reviewing the format of the input data; reviewing one or more previously obtained probabilistic content scores in relation to one or more professional details regarding one or more authors and/or one or more publishing bodies and/or one or more users; considering the content density of the input data; considering the presence of hyperbole and/or propaganda and/or bias within the input data; evaluating the number of claims referenced within the input data, particularly the proportion of verified and unverified claims; and/or examining linguistic cues within the input data as part of a natural language processing (NLP) computational stage.

The algorithmic analysis, which may be performed by one or more neural networks such as convolutional neural networks (CNNs), or an ensemble of supervised and unsupervised classifiers may analyse any part of the input data or data associated with the input data to assist in the generation of the content score. Such analysis can be useful to make the content score more accurate. A “source” may be analysed as being a primary or secondary or tertiary source, depending on where the information was first published. An algorithm may be arranged to analyse all outbound links of the references and automatically ascertain how reliable they are as references. For example, the content and/or truth scores of all outbound links may also be analysed. The outbound references may be analysed in order to determine how semantically well matching the references are to claims to which they are referenced, and whether or not good supporting facts are present. Algorithms may be provided which are operable to establish how well structured an argument is with reference to supporting facts, compared to an opinion or sentimental piece of writing. This may be provided as part of an ensemble algorithm.

Optionally, the method further comprises stance detection in relation to the input data. Optionally, the stance detection comprises analysing data from a plurality of trusted sources. Optionally, the data from a plurality of trusted sources relates to the same subject matter as the input data, and/or further optionally wherein the data from a plurality of trusted sources comprises crowdsourced data.

Stance detection can show a bias towards a particular point of view when reporting on an event, and such stances may be classified as for or against a particular headline or point of view. Many journalists and publication bodies pride themselves on an element of impartiality, but this may not be present in their work. If the same event is reported from multiple sources in the same way, then a bias is less likely. However, if a similar event is detected from multiple sources, and a further source details the same event from a very different perspective, then it is more likely that a bias is present, and this can be reflected in the content score. If a plurality of trusted sources also agrees with the headline that is being read by a user, for example if

they are also reporting the claim and agree it is true or the event has happened, then this may be taken into account when establishing the stance of the article.

Optionally, the reference data is selected from a database. Optionally, the database is stored in one or more computational clouds.

Reference data may be particularly effective when automated or assisted fact checking is required against reference data which is known to be factual, for example economic statistics. Such facts may be provided from open application programming interfaces (APIs) from governments. Digital crawlers may be constructed to gather other open facts, for example research papers, journals, and/or Wikidata from Wikipedia. Storing a database in a computational cloud may make the arrangement disclosed herein more reliable. If a physical machine performing the method were to malfunction, a similar machine can take over the task as the relevant information required may be accessed by any machine with an internet connection.

Optionally, the method further comprises the step of: generating an overlay in relation the input data, the overlay comprising one or more content scores in relation to the input data.

An overlay, for example a pop-up graphic over a piece of online text, can provide a useful and immediate source of information for a user. There is no need for them to take any additional effort, and they may enjoy the information provided to them via the content score and act accordingly. The overlay could take the form of a pop-up or a modal on top of the individual claims themselves, as well as over the whole input data, and provide labels or tags for individual aspects of the body of data, for example “BIAS!”, or “UNREFERENCED CLAIM!”.

Optionally, the method further comprises the step of: compiling a plurality of content scores into a truth score.

If a series of content scores are provided, for example content scores relating to a number of claims in an article or document, then a truth score may be established showing the trustworthiness of that particular article or document. Additionally, automated fact checking may be provided as a sub-component of an automated content score. Assisted fact checking tools/technology may be used to obtain a crowdsourced content score. The automated content score as well as the crowdsourced content score may together be used to generate an overall truth score.

Optionally, the method further comprises the step of: compiling a plurality of content scores and/or truth scores into a credibility index.

The credibility index can refer to a score for a large number of articles from a particular source, a particular writer, or in relation to a particular event. For example, the credibility index maybe arranged to over time look at, per domain, which organisation has the lowest-scored articles, or which journalists write the worst article or post, or Tweet the lowest-scored content. The credibility index may be presented in the form of a graph database of journalists, users, journals, domains and their trust scores (with may be crowdsourced/assisted and automated) over time.

Optionally, the method further comprises the step of providing the probabilistic content score to a search engine and/or a news feed, wherein the probabilistic content score is used to rank results delivered by the search engine and/or the news feed. Alternatively, the method further comprises the step of providing the truth score to a search engine, the truth score used to rank results delivered by the search engine. As a further alternative, the method further comprises the step of providing the credibility index to a search engine, the credibility index used to rank results delivered by the search engine.

Using the content score, truth score, or credibility index to rank results in a search engine may ensure that results which are not accurate, are ‘clickbait’, or are otherwise untrustworthy do not appear at the top of search results, with the aim of ensuring that only accurate subject-matter is made available to a user.

Optionally, the method further comprises the step of providing the truth score to the search engine and/or the news feed, wherein the truth score is used to rank results delivered by the search engine and/or the news feed. Alternatively, the method further comprises the step of providing the truth score to a news feed, the truth score used to rank results delivered by the news feed. As a further alternative, the method further comprises the step of providing the credibility index to a news feed, the credibility index used to rank results delivered by the news feed.

Using the content score, truth score, or credibility index to rank results in a news feed may ensure that results which are not accurate, are ‘clickbait’, or are otherwise untrustworthy do not appear in, or for example are placed at the bottom of the information presented in a news feed, with the aim of ensuring that only accurate subject-matter is made available to a user.

Optionally, the method further comprises the step of providing the credibility index to the search engine and/or the news feed, wherein the credibility index is used to rank results delivered by the search engine and/or the news feed.

Optionally, further comprising a step of manually determining and/or verifying the probabilistic content score, wherein the manual determination and/or verification is provided via a user interface.

Optionally, the user interface is provided by an annotation tool, optionally wherein the user interface provides the one or more users a platform for any one or more of: manually assigning a probabilistic content score; manually adjusting the one or more adjustable weights in relation to the input data; detecting assertions, rumours and/or claims; helping find reference sources against which to fact-check; assisting to determine one or more viewpoints within the textual content and/or video content; assessing the provenance of the one or more headlines in relation to the input data; and/or assisting with a semi-automated probabilistic content scoring procedure; and/or further optionally wherein the user interface carries out an onboarding process for the one or more users, develop reputation points for effectively moderating textual and/or video content and assigning and/or verifying the probabilistic content score.

According to a further aspect, there is provided an apparatus operable to perform the method disclosed herein.

According to a yet further aspect, there is provided a system operable to perform the method disclosed herein.

According to another further aspect, there is provided a computer program product operable to perform the method and/or apparatus and/or system disclosed herein.

Such an apparatus may be useful for putting the method into effect in an efficient manner. Therefore, a greater number of users will be able to benefit from the content scores provided.

### BRIEF DESCRIPTION OF THE DRAWINGS

Embodiments will now be described, by way of example only and with reference to the accompanying drawings having like-reference numerals, in which:

FIG. 1 shows an example of a system within which content scoring may be used;

FIG. 1a is an expanded section of FIG. 1, more specifically detailing various claim channels and the automated misleading content detection algorithm;

FIG. 1b is an expanded section of FIG. 1, more specifically detailing the different claim groups within the system;

FIG. 1c is an expanded section of FIG. 1, more specifically detailing outputs of the fact checking network and platform and various product lines;

FIG. 2 shows a further example of a system within which content scoring may be used;

FIG. 3 illustrates a flowchart of truth score generation including both manual and automated scoring;

FIG. 4 shows an overlay generated using the arrangement disclosed herein; and FIG. 5 shows an example of a claim tagging user interface for annotating claims.

### SPECIFIC DESCRIPTION

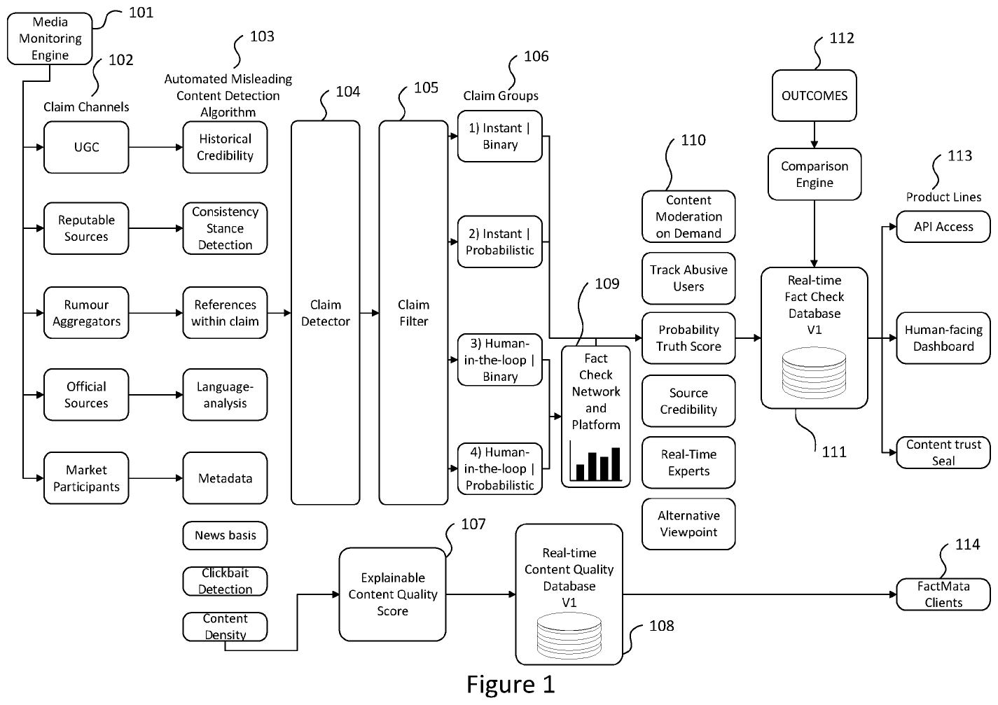

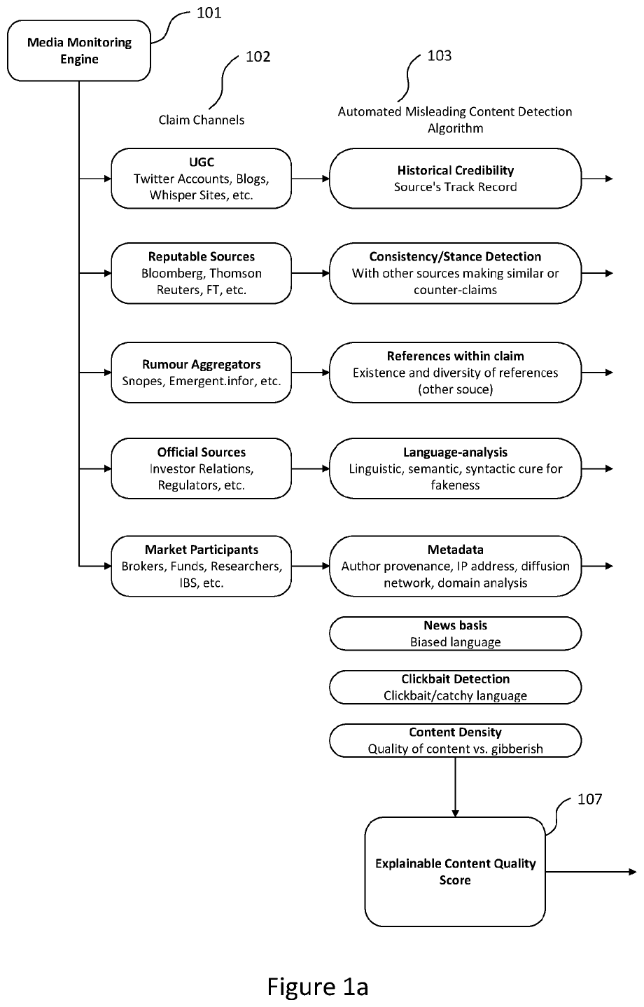

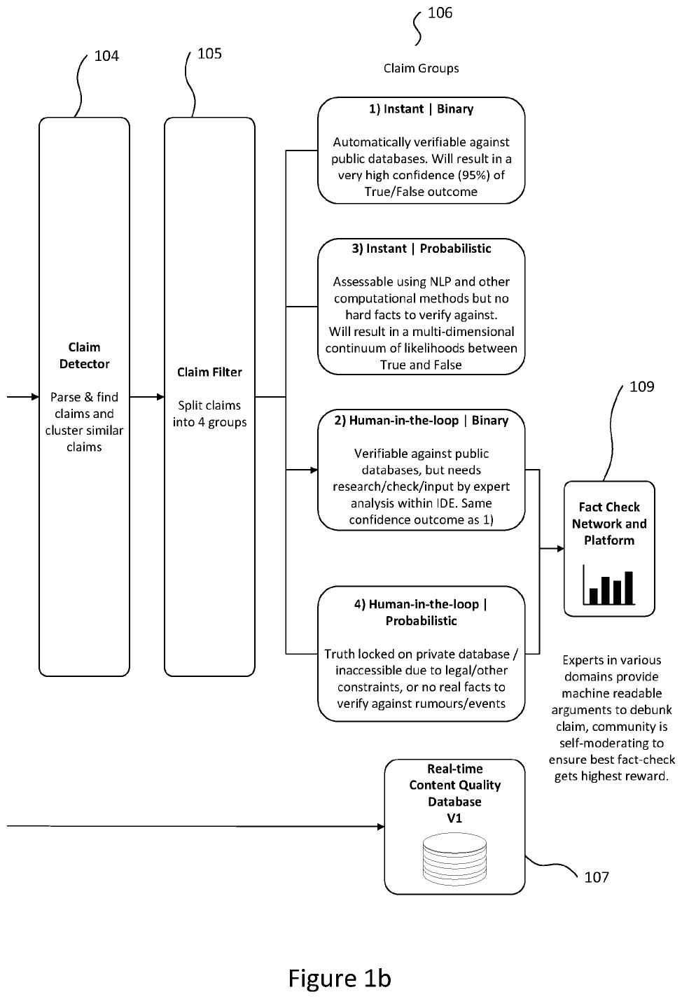

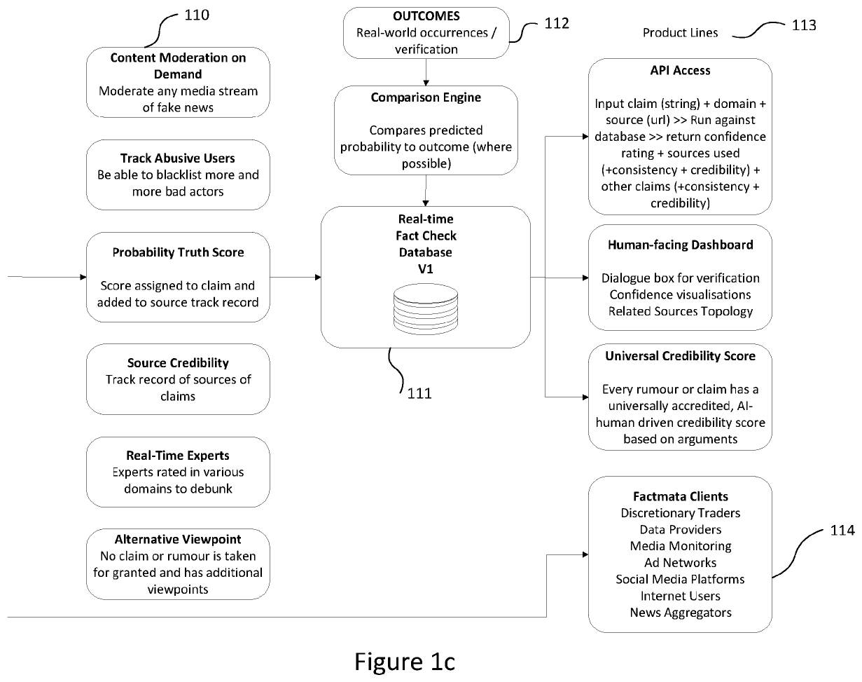

Referring to FIGS. 1 to 4, a first embodiment will now be described.

An automatically calculated score may be embedded as a badge on content itself or within the schema mark-up of a piece of content, and provide a reasoned, open explanation for why it provides, for example, a “B+ rating” on a piece of content. A conventional rating system may be established, for example “A+” for content which is very well known and certified to be true, and “F” for content which is definitely false.

Content is proving increasingly difficult for users to detect bias and judge for provenance and quality. The rise of user-generated content has resulted in a considerable amount of content online being produced without fact checking standards or editorial policy, so judging conformity to such a policy is needed to empower any reader of content to judge the truth of such content. Thus, there is an unprecedented need for a truth “layer” or similar overlay on content that can identify such content as being fake, misleading or false, and then verify the claims and information made in the content itself.

The system and method of this embodiment as described herein substantially provides a comprehensive system to automatically detect and verify misleading textual or video content, using at least in part natural language processing and information retrieval techniques. A piece of content, or a smaller element within a piece of content, may be scored probabilistically for truth-worthiness. Such an element may include, for example, a supposedly factual statement within a larger article. The statement itself may be reliably ascertained to be true, but the article itself may be misleading. Based on known measures of journalistic quality, the system and method for content scoring may identify the quality of the content and, in particular, how accurately it reports information based on facts rather than bias or hyperbole. The probabilistic content score may use one or more algorithmic methods in combination or ensemble, with adjustable weights, to judge the content for quality. Such algorithmic methods may ascertain, for example, one or more of:
1. “Clickbait” detection of the headline;
2. Checking if the content has been reported by a whitelist of trusted credible news sources (“credible sources”);
3. Stance detection against credible sources reporting the same content to detect whether they support, reject or are neutral in stance on the content;
4. Stance detection to see how much the headline matches the content of the article;
5. The domain of the article and if it comes in an untrusted format;
6. The author of the article and previous credibility score on content they have written previously;
7. The “about us” or similar page of the domain if it contains one;
8. The content density of the article; and/or
9. The hyperbole or propaganda density of the article when describing a news event.

“Clickbait” refers to a method of obtaining an interest from a user in an article, generally using a sensationalist or highly exaggerated headline. A user then clicks on what appears to be a very interesting or informative article, which, usually, does not live up to expectations. The term “clickbaitedness” may refer to a level of “clickbait” detected as part of an article. A semi-automated or ‘assisted’ fact-checking arrangement involving human checking methods to assign the same score to content, may be provided. Such a semi-automated arrangement may include any of the preceding algorithmic methods, and/or one or more of:
1. How many claims are referenced in the article with a link;
2. How many claims are fact-checked as true vs. unverified claims; and/or
3. How many claims are from first hand, secondary or tertiary sources and how many claims are sourced from somewhere else.

Illustrating an example embodiment of a content scoring system in order to determine a content score is FIG. 1. FIG. 1 shows a flowchart of the fact checking system starting from a media monitoring engine 101. Media content/online information from claim channels 102 such as UGC, reputable sources, rumour aggregators, official sources and market participants are collected and input into an automated misleading content detection algorithm 103. Claim channels 102 are not limited to the specific examples aforementioned or examples detailed in Figure is and some embodiments may include content provided by other sources.

As depicted in FIG. 1, the automated misleading content algorithm/detector 103 forms the first major part of the system. This module takes in content from several media monitoring systems 101 and analyses it based on various natural language processing techniques for identifiers that it could be fake or misleading, as well as generally scoring the content for its quality. In short, these may include:
1. The original domain and IP address of the news article and whether it may be produced and distributed by a bot network based on pattern analysis, or whether it is a clear copy of a real and trusted domain with a modification.
2. Weighted classification to suspect an article, including missing citations, author names, ‘about us’ section, spelling errors, out of context quotes, one-sidedness, outrageousness.
3. Crowdsourced data on article trustworthiness and/or any other characteristic in relation to the content.
4. A comparison of the headline to the article body for “clickbait” detection.
5. Identification of how “clickbait” the headline is.
6. The stance of reputed news agencies to the article: support, agree, disagree, discuss, unrelated.
7. And other methods.

As illustrated in FIG. 1a, the automated misleading content detection algorithm 103 consists of various analysation techniques. Namely, analysing historical credibility, consistency/stance detection, references within claims, language analysis e.g. linguistic and semantic analysis, metadata, bias, clickbait detection and content density.

A claim detection system may be present in a fact checking system whereby it deploys annotated claims from experts/journalists/fact-checkers. An example claim annotation system by Full Fact is shown in FIG. 5. In this example embodiment, Briefr is used. You can see a user generated “citation needed” tag which leads to the claim label as shown as 501.

Briefr is an existing news sharing and annotation platform which was built for annotating and discussing content. Users share “briefs”, which are posts containing a link to an article along with a comment and one or more tags (Eyeroll, Bravo, Disagree, Agree, Question, Citation

needed, Sad, Funny, Hateful, Lovely, One-sided, Fair). The primary purpose of Briefr up until now has been to gather training data for machine learning models while at the same time serving as an engaging platform for news enthusiasts. As such, the usefulness of the tags for machine learning training data has been balanced with the need to make them interesting to Briefr users.

The next phase is to develop a specific workflow for a citation needed tag. In order to suggest the type of claim it would require an action such as a click, a comment(s) may be inputted, and an evidence link/URL may be provided via the browser extension. In this way, the workflow process retrieves various data such as:
What is the claim;
Explanation/fact check/comment for that claim;
Evidence which would be submitted as a link for that claim; and
Counter-claim (the sentence that contradicts the claim or gives a different view of the facts), the machine may or may not extract automatically from the evidence URL, or the user may input the evidence into a text box.

In an example embodiment, a claim detector 104 may be present to detect, parse and cluster claims. A claim filter 105 may also be present which groups claims into separate categories as shown in FIG. 1b. According to at least one embodiment, in the case of a complex claim (one that the system cannot automatically verify), the assistance of a human fact checker is needed. This is referred to as humans-in-the-loop. For example, claim groups may include:
1) Instant and binary: Automatically verifiable against public databases and will result in a very high confidence true/false outcome.
2) Instant and probabilistic: Assessable using NLP and other computational methods but no hard facts to verify against. This may result in a multi-dimensional continuum of likelihoods between true and false.
3) Human-in-the-loop and binary: Verifiable against public databases but needs research/check/input by an expert analyst. The confidence outcome may be similar to that of an instant and binary claim group.
4) Human-in-the-loop and probabilistic: Truth locked on private database/inaccessible due to legal/other constraints, or no real facts to verify against rumours/event.

Content clustered into one or more human-in-the-loop claim groups can be input into a fact checking network and platform 109 where experts in various domains provide machine readable arguments in order to debunk claims. Alternatively, there may be a semi-automated or manual content scoring network and platform 109 where experts in various domains provide reasoned/explained content scores for claims. In this way, the community is self-moderating in order to ensure the best fact-check receives the highest reward.

Real-time content quality and content scoring databases are used to store data for training algorithms as well as to determine a quality content score and are used to enhance the system's automated fact checking capabilities.

In embodiments algorithms are substantially domain-adaptable, given that users may provide data from a variety of sites (social sites, news, political blog posts, lifestyle blogs, etc). For that, data is aggregated from the various sources and stratified sampling may be implemented to build the training and the test datasets. The final performance metric may be based on a test dataset that encompasses a variety of sources. In terms of process, datasets are gathered from open sources or from research papers. After carrying out error analysis, one or multiple annotation exercises are run on a sample of customer data, and which is used to re-train the model.

Some models may be built to be used as stand-alone detectors, feeding the predictions directly to customers, such as the hate speech and hyperpartisan models. The performance of these models needs to be high on a variety of sites. Other models fulfil a different function which is to be used as nonlinear high-level features to the main algorithms. This is the case for the quotation detection and clickbait models. Both were developed after identifying cases where the main algorithms failed and provide powerful signals. Types of detector models which can influence a content score include: Hate speech, hyper partisanship, fake news, controversy detection, clickbait, Quotation detection and topic detection models.

In terms of the data, various annotation exercises can be implemented on both crowdsourcing platforms (Crowdflower, Mechanical Turk) and other expert annotation platforms such as BriefR.

For example, on a platform such as Mechanical Turk, a proprietary test to identify the best annotators of hyperpartisan content in a pool of workers i.e. to identify expert hyperpartisan annotators. In an embodiment, task may be set to annotation platform communities. These tasks may include:
Asking the user to agree or disagree with an existing classification (presented as an annotation) on a URL.
Asking the user to provide an annotation on a URL.
Asking the user to provide a URL to support an assertion (citation needed).

In embodiments there may be two personas as follows: A client i.e. the person or organisation setting the job, who wants to either validate an existing classification, ask for a new classification, or ask for URLs related to a comment; an annotator i.e. a casual, uncontracted user, who wants to earn prestige and satisfaction by completely small, convenient tasks on an ad hoc basis. They are likely to be a freelance journalist or expert communicator/annotator. In assigning tasks, there are three key words to take into account. Annotation tasks include a single URL annotation performed by a single annotator, an annotation item includes a single URL/quote that needs to be annotated by one or more annotators and an annotation job defines a collection of annotation items submitted to the Briefr community.

There may be various factors the client may consider from submitting a job/task to a particular community, tracking the progress of a task, managing accounts and annotators may wish to discover annotatable tasks. In various embodiments, there may be provided a system/UI/API and method to highlight or include the various factors which are detailed in this description. A person skilled in the art will recognise that the factors and influence point for clients and annotators are not limited to that which is noted in this description alone.

In submitting a job or a task, the client may want to submit a collection of URLs, optionally including initial classifications, into Briefr or classifiers within the system, such that they can be annotated, specify the type of annotation to be performed, such that the annotator knows what to do, specify in some way the subset of the community that should do the tagging, to provide explainability and get the best results. The client may also want to specify the cost per annotation for the overall annotation job, and see an estimate of the total job cost, in order to keep control of spending. The client may want to specify the minimum and maximum number of annotators per annotation item so that they can ensure quality and may want to specify an expiry date for the overall annotation job so that jobs have a finite time limit.

In tracking the completion of a particular job, the client may want to be able to track the progress of the overall annotation job so that they understand how complete it is, see a list of annotation items, and see how many times each has been annotated, so they can understand how complete the job is and also see an overall completion percentage, time spent so far, time remaining, and budget spent so far, in order to understand progress of the task in hand. The client may want to change the budget, community requirements, time limit or number of annotators per annotation required at any time while the overall annotation job is in progress so that they can tune the job and see how many annotators are available to complete tasks,

given the community requirements set. The client may want to be able to download or export the results of the overall annotation job at any time in the form of a CSV file so that they can do post-processing for their own reports.

Through the content scoring system, it may be possible to monitor the performance of the community including factors such as the time taken per annotation, how often is there consensus, how long does it take to reach consensus, how many annotators, tracking individual user performance e.g. annotation time, tendency to agree or disagree and the detection of bad actors.

In managing Accounts, the client may want to be able to pay money into an account to make funds available for annotation tasks, see their current balance at any time so they can keep track of their balance and both client and annotator may want to be able to withdraw unspent funds from their balance so that they can access funds.

In order to create a sustainable annotation platform, annotators need to be notified when new tasks are available, so they are aware of them, annotators need to be able to access a list of paid annotation tasks relevant to them, so they can complete new tasks, they need clear simple instructions for each task, so they know what to do and annotators may also need to know how much they get paid for each task. Annotators need to understand on some level who they are completing the task for, so they can provide informed consent. Annotators need a clear signal when the annotation task is completed, crediting the money to their account, and ensuring that the annotation item is no longer available and annotators may want their annotations to be invisible to other users, and not posted in main feeds.

The system/U1/API activity may be tracked by pre-set and/or manually set metrics which may provide information such as the total number of annotated tasks, total cost, total time spent, average time spent for each annotation etc. The system may also enable the client and annotator to access a multitude of functions in order to, for example, retruice/edit the current task description, expiry date of a particular task, task type, cost per annotation task, as well as to upload new tasks and download data etc.

Two of the main challenges of the machine learning (or ML) models are making sure the models are fair and up-to-date. News stories and threats keep changing every day, and it is necessary to be able to detect new content. For example, for models to be “fair” and not too biased (i.e. only detecting right-wing stories as hyperpartisan content), it is required to make sure that the training data has been collected from a balanced set of annotators which is

representative from the set of views we would like to incorporate into our models. In order to achieve these two goals, a unique set of communities of experts/users will provide the human-in-the-loop in order to annotate new trending stories etc. Models may be used to identify the top toxic trending stories, which will then be given to annotators to remove false positives. Then, in order to increase the recall of classifiers within the system, data which is directly reported/flagged by our communities of experts, as well as take an unsupervised approach to find the top trending themes will be used. In some embodiments, stories/content coming from both the supervised approach and unsupervised, will be then fed to experts/annotators as a final check to get a labelled set of toxic stories. These articles can then be fed back into the machine learning (or ML) models to re-train them as well as updating content scores.

FIG. 1 also illustrates example outcomes from inputting content from various claim channels 102 to an automated misleading content detection algorithm 103, a claim detector 104 and a claim filter 105. The outcomes are more specifically described in FIG. 1c, and these include, but are not limited to, as shown as 110, the following:
1) Content moderation on demand: moderation of any media stream for fake news.
2) Tracking abusive users: The ability to blacklist more and more bad actors.
3) Determining a probability truth score: Assigning a score to a claim which may be added to a source track record.
4) Determining source credibility: Updating track records of sources of claims.
5) Annotations by real-time expert analysts: Rating provided by experts in various domains in order to debunk content.
6) Providing alternative viewpoints: No claim or rumour is taken for granted and has additional viewpoints.

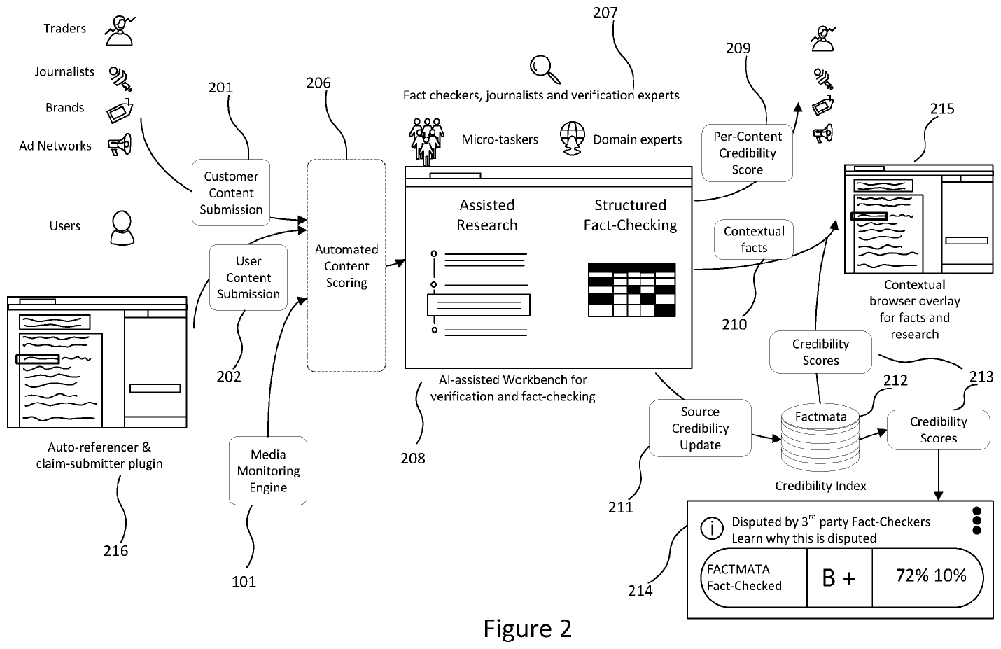

FIG. 2 depicts an “Automated Content Scoring” module 206 which produces a filtered and scored input for a network of fact checkers. Input into the automated content scoring module 206 may include customer content submissions 201 from traders, journalists brands, ad networks user etc., user content submissions 202 from auto-reference and claim-submitter plugins 216 and content identified by the media monitoring engine 101. The content moderation network of fact checkers 207 including fact checkers, journalists, verification experts, grouped as micro taskers and domain experts, then proceeds by verifying the content as being misleading and fake through an Al-assisted workbench 208 for verification and fact-checking. The other benefit of such a system is that it provides users with an open, agreeable quality score for content. For example, it can be particularly useful for news aggregators who want to ensure they are only showing quality content but together with an explanation. Such a system may be combined with or implemented in conjunction with a quality score module or system.

This part of the system may be an integrated development environment or browser extension for human expert fact checkers to verify potentially misleading content. This part of the system is particularly useful for claims/statements that are not instantly verifiable, for example if there are no public databases to check against or the answer is too nuanced to be provided by a machine. These fact checkers, as experts in various domains, have to carry out a rigorous onboarding process, and develop reputation points for effectively moderating content and providing well thought out fact checks. The onboarding process may involve, for example, a standard questionnaire and/or based on profile assessment and/or previous manual fact checks made by the profile.

Through the Al-assisted workbench for verification and fact-checking 208, a per-content credibility score 209, contextual facts 210 and source credibility update 211 may be provided. The source credibility update may update the database 212 which generates an updated credibility score 213 and thus providing a credibility index as shown as 214 in FIG. 2. Contextual facts provided by the Al-assisted user workbench 208 and credibility scores 213 my be further provided as a contextual browser overlay for facts and research 215.

Real-time content quality and fact check databases 108 and 111 are used to store data for training algorithms as well as to determine a quality fact check and are used to enhance the system's automated fact checking capabilities. The data within the real-time content quality database may be delivered to users e.g. clients 114. On the other hand the real-time fact check database in provided to product lines 113, for example API access, human-facing dashboard and content trust seal.

The assisted fact checking/content scoring tools have key components that effectively make it a code editor for fact checking/content scoring, as well as a system to build a dataset of machine readable fact checks, in a very structured fashion. This dataset will allow a machine to fact check content automatically in various domains by learning how a human being constructs a fact check, starting from a counter-hypothesis and counter-argument, an intermediate decision, a step by step reasoning, and a conclusion whereby a content score may be generated or determined. Because the system can also cluster claims with different phrasings or terminology, it allows for scalability of the system as the claims are based online (global) and not based on what website the user is on, or which website the input data/claim

is from. This means that across the internet, if one claim is debunked it does not have to be debunked again if it is found on another website.

In an embodiment, a user interface may be present wherein enabling visibility of labels and/or tags, which may be determined automatically or by means of manual input, to a user or a plurality of users/expert analysts. The user interface may form part of a web platform and/or a browser extension which provides users with the ability to manually label, tag and/or add description to content such as individual statements of an article and full articles, as shown as in 106.

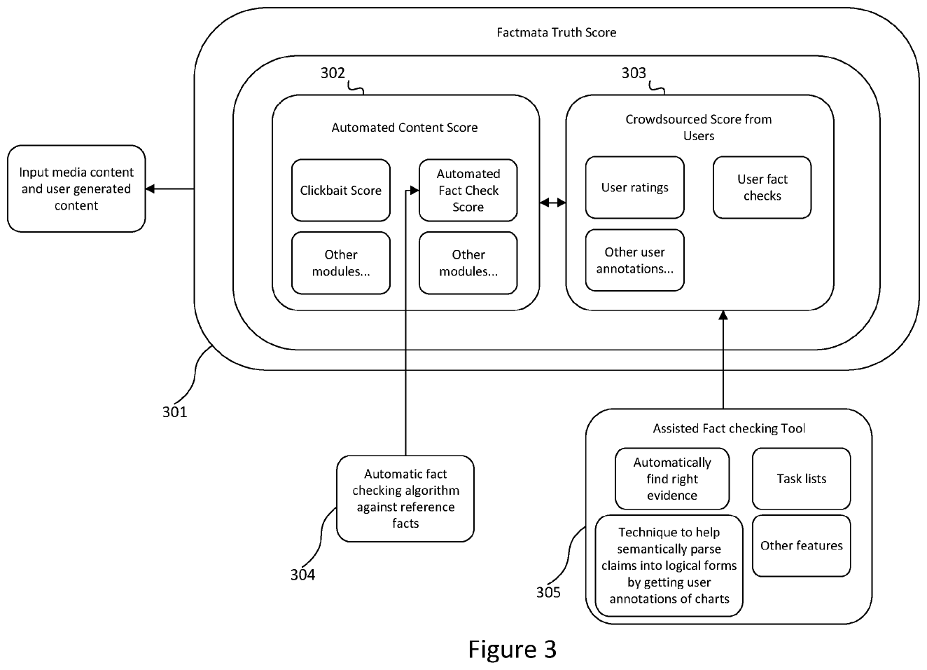

FIG. 3 illustrates a flowchart of truth score generation 301 including both manual and automated scoring. A combination of an automated content score 302 and a crowdsourced score 303 i.e. content scores determined by users such as expert annotators, may include a clickbait score module, an automated fact checking scoring module, other automated modules, user rating annotations, user fact checking annotations and other user annotations. In an example embodiment, the automated fact checking scoring module comprises an automatic fact checking algorithm 304 provided against reference facts. Also, users may be provided with an assisted fact checking tool/platform 305. Such tool/platform may assist a user(s) in automatically finding correct evidence, a task list, techniques to help semantically parse claims into logical forms by getting user annotations of charts for example as well as other extensive features.

An algorithm (optionally a learned algorithm) may be used to generate an automated score to a fact checker to verify using complex natural language processing and add to the overall content score. This may be in the form of a probabilistic score, wherein the inputs may be defined as one or more of the following and provided with associated weights: “clickbaitedness” of the headline; how much the body of the text matches the headline; what is the stance of reputed agencies to the headline claim made; how many references the article contains; how many articles of this topic the author has written, or if they are new to the topic; how much gibberish the language contains; how biased the article is to one actor or one viewpoint; how logically formed the argument of the article is; automatically fact check some claims of a numerical or logical nature; and/or if the domain of the article is from a less well known domain from the below historical whitelist of domains which will be built up using the crowd. Such an algorithm may be based on the elements shown in FIG. 3, with particular reference to the item labelled 1.

Another set of algorithms and/or similar technology may be used to automatically assist a fact-checking network with their fact checking process, which may lead to a crowdsourced score. Such assistance may include one or more of:
detecting assertions, rumours and/or claims in bodies of text using machine learning methods (which may include neural networks), the said assertions, rumours, and/or claims requiring fact-checking;
helping a user find reference sources against which to fact-check (which, for example, may include a claim about economic growth presented alongside a link to a World Bank data source against which to check, with the correct country and date filled in); splitting media data into clusters of viewpoints, and for the same story, stories that are for or against a target individual or claim in nature;
assessing the provenance of the headline, including who was the original reporter of the story, for example a Tweeter or the Associated Press;
starting to provide, automatically, a task list for a fact checker for any given claim or rumour, in terms of the steps to take to check it which may be different based upon the content of the claim;
providing alternative sources for each topic in the body of an article, and additional context including graphics, further reading and so on;
assessing how much text has been copied from another article that is already known about;
assessing information about the author and/or persons identified in the story;
identifying quotations which have been misquoted from their original quotes in source material;
providing a button for a fact-checker to open, automatically, a set of tabs on their browser pre-searched with the key terms;
providing a fact checker with a chart or table from a factual source appropriate to the fact they should be checking;
providing a fact checker with the correct link to visit to fact check content; and/or
allowing a fact checker to score the content from 1-10.

In these ways, a score may effectively be crowdsourced.

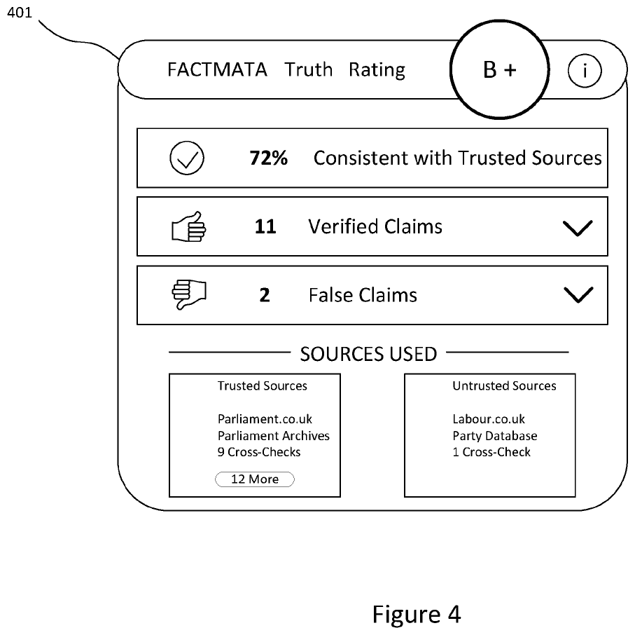

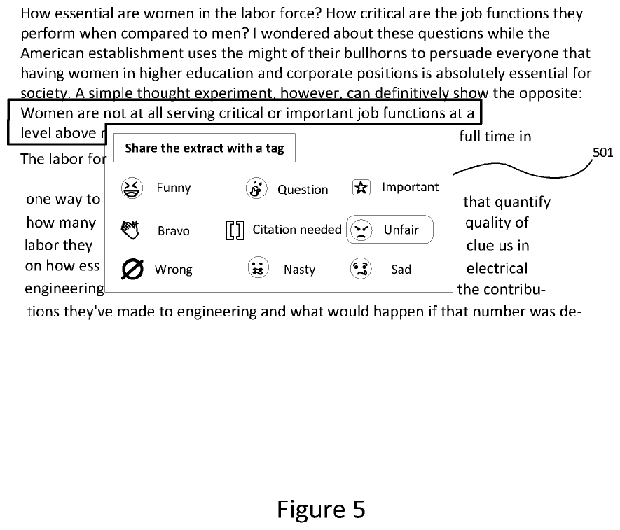

The system and method of this embodiment as described herein is operable to provide a user with an open, agreeable quality score for content 401, an example of which is shown in FIG. 4. For example, a news aggregator may want to ensure that they are only displaying content of a certain quality and wish to explain why certain articles have not been included. There is provided herein a mechanism for such a system, which may include an automated misleading content detection algorithm. An agreeable content quality score may be provided along with data such as the percentage of trusted sources, verified claims, false claims, as well as different sources investigated.

Further, the system and method of this embodiment as described herein may provide an integrated development environment or browser extension network for human expert fact checkers to verify potentially misleading content. This system may be used for claims which are not instantly verifiable, for example if there are no public databases against which to check, or the answer is too nuanced to be provided by a machine at the present time. Such human fact checkers may be experts in various subject-matter areas and/or domains, may carry out a rigorous onboarding process, and develop reputation points for effectively moderating content and providing well thought out fact checks.

Such a system may be provided with components which effectively make it a code editor for fact checking. Additionally, a system to build a dataset of machine readable fact checks in a very structured fashion may be provided. Such a dataset may allow a machine to fact check content automatically in various domains by learning how a human being constructs a fact check and may include the steps of starting from a counter-hypothesis and counter-argument, forming an intermediate decision, carrying out step by step reasoning, and reaching a conclusion. As the system may become effective at clustering claims with different phrasings, it may be scalable—claims are conventionally made on a global online basis, and not based on which particular website a user is on. This means that across the internet, if one claim is debunked, it does not have to be debunked again if appearing on a new website.

Further, the weights of a misleading content module may be adjusted to tailor the scoring. For example, if a client or consumer of the system and method described herein believes that “clickbaitedness” is a more accurate indicator of what they want to be flagged to their content moderation network to enhance recall of misleading content, they can increase the weighting attributed to this factor. The system and method described herein may also include some elements of explainable artificial intelligence or machine learning, where the algorithm or algorithms at play may explain and account for the reasoning applied.

In example embodiments, sample indicators for a potential content score may include the following:
Article structures: subject area, language (source language and translated language if there has been a translation), publication site, length, originality, headline, genre, factual assertions, dateline (location and date), correction, author, article awards etc.—Article metadata: subheading, publication domain information, article rights, geotags etc.
Author reputation: track records, public accessibility, occupation, number of publications, author bio, followers, educational credentials etc.
Claim: factcheck results of a claim(s), misleading assertions, logical fallacy, false assertions, bad/incorrect data etc.
Inbound references: verdicts from fact checking platforms, comment to like ratio, Wikipedia links, social media links, news site links, content shares, content engagement data etc.
Journalistic data: representative of scientific process or literature, presents multiple perspectives etc.
Logic/reasoning: use of conspiratorial thinking, supporting claim types, straw man arguments, slippery slope type arguments, orders of understanding, number of argument components, supporting premises, number of claims, number of attacking premises, arguments for and against, naturalistic fallacy, bias, level of confidence etc.
Outbound references: source types, quotes from reputable sources, number of links, videos embedded, scientific journal links, image macros, attributed images, original images, accuracy of representation of source article etc.
Publication: metadata, site analytics, publisher, publication type, publication name, publication start/end date, publication domain, niche topic, masthead, language, Wikipedia entries etc.
Reader behaviour: volume of readership, emotional responses, common referrers, average time spent etc.
Other indicators may include revenue model variables, rhetoric variables such as spelling errors, overly emotional language, hate speech, Hyperbolic language, profanity, astroturfing and apophasis etc.

A potential benefit of at least some embodiments of the system and method described herein is the provision of a substantially instantaneous indicator of how trustworthy a piece of information is. In the past, such indicators may have been based solely on the publication, the individual author, past history of the publication source, and/or a personal relationship to the writer. The content scoring system and method disclosed herein allows for an objective, explainable mechanism for scoring language in a similar way to a journalist or English teacher may score content, only applied instantly to any content for fact-worthiness. This could be used by online fact-checkers to know what content they should fact-check, or within a community of fact checking experts in a human-in-the-loop AI/ML platform, or even by financial traders knowing what streams of content they should trust over others to contain real,

trustworthy action items. A user may therefore be able to check in substantially real time the extent to which a claim is credible. This concept of scoring content can also be used by social platforms like Facebook or Google to be able to display to their users or even to internal teams how trustworthy their content is and provide a measure to be able to flag false items instantly or judge their false news detection processes.

Optionally, all algorithms and method described above as embodiments or alternative or optional features of the embodiments/aspects may be provided as learned algorithms and/or method, e.g. by using machine learning techniques to learn the algorithm and/or method.

Machine learning is the field of study where a computer or computers learn to perform classes of tasks using the feedback generated from the experience or data gathered that the machine learning process acquires during computer performance of those tasks.

Typically, machine learning can be broadly classed as supervised and unsupervised approaches, although there are particular approaches such as reinforcement learning and semi-supervised learning which have special rules, techniques and/or approaches. Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets. Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled. For unsupervised machine learning, there is a range of possible applications such as, for example, the application of computer vision techniques to image processing or video enhancement. Unsupervised machine learning is typically applied to solve problems where an unknown data structure might be present in the data. As the data is unlabelled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a

technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi-supervised machine learning makes use of externally provided labels and objective functions as well as any implicit data relationships. When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training, and could also mean that the machine learning process does not converge to good solutions for all or specific examples). The user must also determine the desired structure of the learned or generalised function, for example whether to use support vector machines or decision trees.

The use of unsupervised or semi-supervised machine learning approaches are sometimes used when labelled data is not readily available, or where the system generates new labelled data from unknown data given some initial seed labels.

Machine learning may be performed through the use of one or more of: a non-linear hierarchical algorithm; neural network; convolutional neural network; recurrent neural network; long short-term memory network; multi-dimensional convolutional network; a memory network; or a gated recurrent network allows a flexible approach when generating the predicted block of visual data. The use of an algorithm with a memory unit such as a long short-term memory network (LSTM), a memory network or a gated recurrent network can keep the state of the predicted blocks from motion compensation processes performed on the same original input frame. The use of these networks can improve computational efficiency and also improve temporal consistency in the motion compensation process across a number of

frames, as the algorithm maintains some sort of state or memory of the changes in motion. This can additionally result in a reduction of error rates.

Any system features as described herein may also be provided as a method features, and vice versa. As used herein, means plus function features may be expressed alternatively in terms of their corresponding structure.

Any feature described herein in connection with one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects may be implemented and/or supplied and/or used independently.

1. A method of determining a score indicative of the factual accuracy of information, comprising the steps of:
receiving input data from a network of users, the input data comprising metadata, textual content and/or video content;
providing to the network of users one or more elements of reference data; performing an algorithmic analysis of the received input data in relation to the reference data; and
determining a probabilistic content score based on the algorithmic analysis, wherein the probabilistic content score reflects a verified confidence measure for the input data.

2. The method as claimed in claim 1, further comprising the step of:
automatically detecting the input data as misleading content based on the algorithmic analysis, wherein the misleading content is verified by the probabilistic content score.

3. The method as claimed in claim 1, further comprising the step of:
identifying one or more individual claims within the input data, wherein each individual claim is operable to receive a separate content score.

4. The method as claimed in claim 1, wherein the algorithmic analysis is performed using the metadata associated with the input data.

5. The method as claimed in claim 4, wherein the metadata comprises one or more of: a profile of one or more users; one or more authors; a location; and/or professional details regarding one or more authors and/or one or more publishing bodies.

6. The method as claimed in claim 1, wherein the algorithmic analysis comprises any one or more of:
Reviewing known measures of journalistic quality; reviewing one or more headlines in relation to the input data; reviewing the source of the input data; reviewing the relationship between the source of the input data and one or more users; reviewing the domain from which the input data is received, in particular autobiographical data obtained from the domain; reviewing the format of the input data; reviewing one or more previously obtained probabilistic content scores in relation to one or more professional details regarding one or more authors and/or one or more publishing bodies and/or one or more users; considering the content density of the input data; considering the presence of hyperbole and/or propaganda and/or bias within the input data; evaluating the number of claims referenced within the input data, particularly the proportion of verified and unverified claims; and/or examining linguistic cues within the input data as part of a natural language processing (NLP) computational stage.

7. The method as claimed in claim 1, further comprising stance detection in relation to the input data.

8. The method as claimed in claim 7, wherein the stance detection comprises analysing data from a plurality of trusted sources:
optionally wherein the data from a plurality of trusted sources relates to the same and/or related subject matter as the input data; and/or
further optionally wherein the data from a plurality of trusted sources comprises crowdsourced data.

9. The method as claimed in claim 1,
wherein the reference data is selected from a database:
optionally wherein the database is stored in one or more computational clouds.

10. The method as claimed in claim 1, wherein the step of determining the probabilistic content score based on the algorithmic analysis comprises assigning one or more adjustable weights to the input data.

11. The method as claimed in claim 1, further comprising the step of:
generating an overlay in relation the input data, the overlay comprising one or more content scores in relation to the input data.

12. The method as claimed in claim 1, further comprising the step of:
compiling a plurality of content scores into a truth score.

13. The method as claimed in claim 1, further comprising the step of:
compiling a plurality of content scores and/or truth scores into a credibility index.

14. The method as claimed in claim 1, further comprising the step of:
providing the probabilistic content score to a search engine and/or a news feed, wherein the probabilistic content score is used to rank results delivered by the search engine and/or the news feed.

15. The method as claimed in claim 14, further comprising the step of:
providing the truth score to the search engine and/or the news feed, wherein the truth score is used to rank results delivered by the search engine and/or the news feed.

16. The method as claimed in claim 15, further comprising the step of:
providing the credibility index to the search engine and/or the news feed, wherein the credibility index is used to rank results delivered by the search engine and/or the news feed.

17. The method as claimed in claim 1, further comprising a step of:
manually determining and/or verifying the probabilistic content score, wherein the manual determination and/or verification is provided via a user interface.

18. The method as claimed in claim 17, wherein the user interface is provided by an annotation tool:
optionally wherein the user interface provides the one or more users a platform for any one or more of: manually assigning a probabilistic content score; manually adjusting the one or more adjustable weights in relation to the input data; detecting assertions, rumours and/or claims; helping find reference sources against which to fact-check; assisting to determine one or more viewpoints within the textual content and/or video content; assessing the provenance of the one or more headlines in relation to the input data; and/or assisting with a semi-automated probabilistic content scoring procedure; and/or further optionally wherein the user interface carries out an onboarding process for the one or more users, develop reputation points for effectively moderating textual and/or video content and assigning and/or verifying the probabilistic content score.

19. (canceled)

20. (canceled)

21. (canceled)
